(19) United States
(12) Patent Application Publication
(10) Pub. No.: US 2023/0168500 A1
(43) Pub. Date: Jun. 1, 2023

(54) SMART GLASSES AND CAMERA DEVICE THEREOF

(71) Applicant: MERRY ELECTRONICS (SUZHOU) CO., LTD., Suzhou City (CN)

(72) Inventors: XiaoLong LIU, Suzhou City (CN); Hui WU, Suzhou City (CN); GuangHong YU, Suzhou City (CN)

(73) Assignee: MERRY ELECTRONICS (SUZHOU) CO., LTD., Suzhou City (CN)

(21) Appl. No.: 17/994,168

(22) Filed: Nov. 25, 2022

(30) Foreign Application Priority Data
Nov. 26, 2021 (CN) 202111418970.X

(51) Int. Cl. H04N 5/225; G02B 27/01; G06F 3/041

(52) U.S. Cl. CPC H04N 5/2252; H04N 5/2257; G02B 27/0101; G02B 27/0176; G06F 3/04164; G02B 2027/0138; G02B 2027/0178

(57) ABSTRACT

The present disclosure provides smart glasses and a camera device thereof. The camera device includes a base, a circuit board component, a camera component, and a case. The base has an engaging part, and the engaging part is detachably connected to a temple of a smart glasses body. The circuit board component is disposed on the base. The camera component is disposed on the base and electrically connected to the circuit board component. The case is disposed on the base and covers the circuit board component and the camera component. The case has a camera opening, and a part of the camera component is exposed from the camera opening. The camera device may be detachably connected to the smart glasses through the engaging part on the base, so that the user may quickly change different camera devices according to requirements.

### CROSS REFERENCE TO RELATED DISCLOSURE

This application claims the priority benefit of China Patent Application Number 202111418970.X, filed on Nov. 26, 2021, the full disclosure of which is incorporated herein by reference.

### BACKGROUND

### Technical Field

The present disclosure is related to smart glasses, and in particular, smart glasses and a camera device thereof.

### Related Art

People are keen to share the vision in their eyes with the vigorous development of social networks, so the importance of wearable electronic devices is gradually increasing. For example, compared with a handheld camera device, using smart glasses with a camera to photograph has better convenience and immersion. Therefore, users' reliance on smart glasses with a camera is gradually increasing.

However, existing cameras are usually installed in smart glasses. As a result, maintenance of the camera becomes extremely difficult. In addition, a single type of lens may no longer satisfy users with users' requirements for different image styles. That is, users need a kind of smart glasses that may immediately replace the camera according to the conditions of the place, light, and photographed objects. Therefore, how to quickly and effectively replace the camera on the smart glasses has become an urgent issue to be solved in the art.

### SUMMARY

The embodiments of the present disclosure disclose smart glasses and a camera device thereof, so as to solve the problem in the prior art that the user may not replace the camera device on the smart glasses according to requirements, resulting in poor user experience.

In order to solve the above technical problems, the present disclosure is implemented as follows.

First, a camera device of smart glasses is provided. The camera device includes a base, a circuit board component, a camera component, and a case. The base has an engaging part, and the engaging part is detachably connected to a temple of a smart glasses body. The circuit board component is disposed on the base. The camera component is disposed on the base and electrically connected to the circuit board component. The case is disposed on the base and covers the circuit board component and the camera component. The case has a camera opening, and a part of the camera component is exposed from the camera opening.

In some embodiments, the engaging part has an engaging bottom surface and two engaging walls on two sides of the engaging bottom surface. The engaging bottom surface cooperates with the two engaging walls to form an engaging groove, and the engaging groove is configured to correspond to the temple of the smart glasses body.

In some embodiments, the two engaging walls extend from the engaging bottom surface in a direction away from the engaging bottom surface, and one end away from the engaging bottom surface of each of the two engaging walls is curved towards the other of the two engaging walls.

In some embodiments, the two engaging walls are configured to hold the temple by interference fit.

In some embodiments, the camera device of smart glasses further includes a touching component. Wherein, the touching component is disposed between the circuit board component and the case, and the touching component is electrically connected to the circuit board component.

In some embodiments, the touching component includes a touching circuit board and a touching sensor is electrically connected to each other, and the touching sensor is between the touching circuit board and the case.

In some embodiments, the case includes a bottom plate and a side plate connected to each other. The side plate of the case is bent and extended from one end of the bottom plate. The side plate and the bottom plate of the case form a preset angle. The camera opening is at the side plate. The bottom plate includes an outer surface and an inner surface opposite to each other, and the touching sensor is disposed on the inner surface of the bottom plate.

In some embodiments, the outer surface is a flat surface. An accommodating groove is recessed on the inner surface, and the touching sensor is disposed in the accommodating groove.

In some embodiments, the camera device of smart glasses further includes a first electrical connecting component passing through the base. Wherein, one end of the first electrical connecting component is electrically connected to the circuit board component, and the other end of the first electrical connecting component is used to electrically connect the smart glasses body.

In some embodiments, the first electrical connecting component is a Pogo Pin.

In some embodiments, the engaging part has an engaging bottom surface and two engaging walls on two sides of the engaging bottom surface. The engaging bottom surface cooperates with the two engaging walls to form an engaging groove, and the first electrical connecting component passes through the engaging bottom surface.

In some embodiments, the base includes a bottom plate and a side plate connected to each other. The side plate of the base is bent and extended from one end of the bottom plate. The side plate and the bottom plate of the base form a preset angle. The camera component is at the side plate of the base, and the engaging part is at the bottom plate of the base.

Second, smart glasses are provided. The smart glasses include a smart glasses body and the camera device of smart glasses mentioned above. The smart glasses body includes a frame, two temples, a controlling component, and a battery component. Two temples respectively are disposed on two sides of the frame, wherein at least one of the two temples has a second electrical connecting component. The controlling component is disposed in at least one of the two temples, wherein the controlling component is electrically connected to the second electrical connecting component. The battery component is disposed in at least one of the two temples, wherein the battery component is electrically connected to the controlling component. The camera device of smart glasses is detachably disposed on one of the two temples, wherein the camera device is electrically connected to the second electrical connecting component.

In some embodiments, the smart glasses body further includes a communication component disposed in the two temples, and the communication component is electrically connected to the controlling component.

The camera device of the present disclosure includes a base and a circuit board component, a camera component, and a case located thereon. Further, the camera device may be detachably connected to the smart glasses through the engaging part on the base, so that the user may quickly replace different camera devices according to their requirements. Therefore, a camera device of smart glasses with a stable connection and quick disassembly may be achieved by the present disclosure.

### BRIEF DESCRIPTION OF THE DRAWINGS

The figures described herein are used to provide a further understanding of the present disclosure and constitute a part of the present disclosure. The exemplary embodiments and descriptions of the present disclosure are used to illustrate the present disclosure and do not limit the present disclosure, in which:

FIG. 1 is a schematic diagram of the camera device according to an embodiment of the present disclosure;

FIG. 2 is another schematic diagram of the camera device according to an embodiment of the present disclosure;

FIG. 3 is an exploded view of the camera device according to an embodiment of the present disclosure;

FIG. 4 is a block diagram of the circuit board component according to an embodiment of the present disclosure;

FIG. 5 is a schematic diagram of the smart glasses according to an embodiment of the present disclosure;

FIG. 6 is an exploded view of the smart glasses according to an embodiment of the present disclosure; and

FIG. 7 is a block diagram of the controlling component according to an embodiment of the present disclosure.

### DESCRIPTION IN DETAILED OF THE EMBODIMENTS

In order to make the objectives, technical solutions, and advantages of the present disclosure clearer, the technical solutions of the present disclosure will be described clearly and completely in conjunction with specific embodiments and the figures of the present disclosure. Obviously, the described embodiments are only a part of the embodiments of the present disclosure, rather than all the embodiments. Based on the embodiments in the present disclosure, all other embodiments obtained by a person of ordinary skill in the art without creative work fall within the protection scope of this disclosure.

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

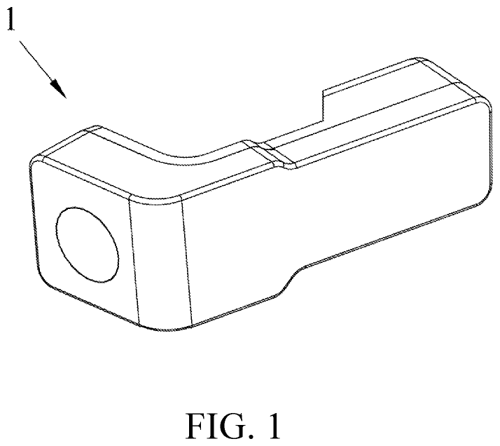

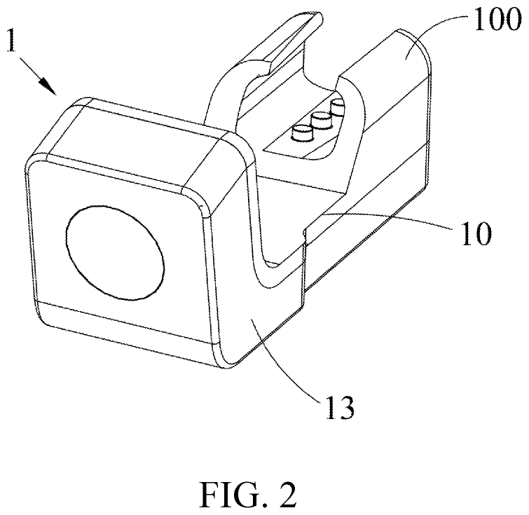

FIG. 1 to FIG. 3 respectively are a schematic diagram, another schematic diagram, and an exploded view of the camera device according to an embodiment of the present disclosure. As shown in the figures, the camera device 1 of the present disclosure is suitable for smart glasses. The camera device 1 includes a base 10, a circuit board component 11, a camera component 12, and a case 13. The base 10 has an engaging part 100 detachably connected to a temple of a smart glasses body. The circuit board component 11 is disposed on the base 10. The camera component 12 is disposed on the base 10 and electrically connected to the circuit board component 11. The case 13 is disposed on the base 10 and covers the circuit board component 11 and the camera component 12. The case 13 has a camera opening 130, and a part of the camera component 12 is exposed from the camera opening 130. The camera device 1 of the present disclosure may be quickly installed on or removed from the smart glasses body with the above configuration, therefore an easy-to-install camera device 1 for smart glasses is achieved. As a result, the user may replace the camera device 1 having different camera components 12 according to actual requirements. Furthermore, each component in the camera device 1 will be described in detail hereinafter in order to make the technical features and technical effects of the present disclosure clearer and easier to understand.

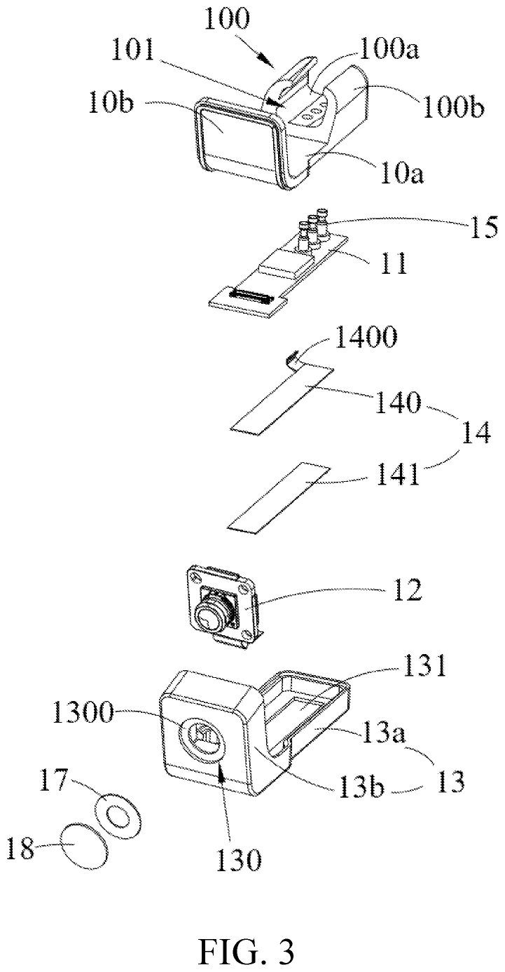

As shown in FIG. 3, in some embodiments, the base 10 includes a bottom plate l0a and a side plate 10b connected to each other. In some embodiments, the side plate 10b of the base 10 is bent and extended from one end of the bottom plate 10a, and the side plate 10b and the bottom plate 10a of the base 10 form a preset angle. For example, the side plate 10b extends in a direction away from the bottom plate 10a from one end of the bottom plate 10a, and the angle between the side plate 10b and the bottom plate 10a is about 90 degrees. Specifically, the side plate 10b and the bottom plate 10a respectively correspond to a frame and the temple of the smart glasses body. Therefore, when the angle between the frame and the temple of the smart glasses body is not 90 degrees, the angle between the side plate 10b and the bottom plate 10a may also be adjusted correspondingly. That is, the present disclosure is not limited to the 90 degrees mentioned above. For example, the angle between the side plate 10b and the bottom plate 10a may be 75 degrees, 80 degrees, 85 degrees, 90 degrees, 95 degrees, 100 degrees, 105 degrees, or a range between any of the values mentioned above. In addition, the camera component 12 is on the side plate 10b of the base.

In some embodiments, the bottom plate 10a and the side plate 10b may be integrally formed, or may be formed separately and then fixed to each other by bonded, welded, assembled, or a method well known by a person having ordinary skill in the art. In some embodiments, a chamfer may be formed between the bottom plate 10a and the side plate 10b to increase the contact area between the two components, thereby avoiding stress concentration on a specific area.

In some embodiments, the engaging part 100 is on the bottom plate 10a. The engaging part 100 has an engaging bottom surface 100a and two engaging walls 100b on two sides of the engaging bottom surface 100a. The engaging bottom surface 100a is on the bottom plate 10a, and the engaging bottom surface 100a cooperates with the two engaging walls 100b to form an engaging groove 101. The engaging groove 101 is configured to correspond to the temple of the smart glasses body. For example, the size of the engaging groove 101 may be the same as or slightly smaller than the size of the temple of the smart glasses body. As a result, the engaging walls 100b may stably fix the temple of the smart glasses body therein. In some embodiments, the engaging walls 100b may also be provided with a high friction coefficient anti-skid layer, texture, etc., to improve the fixing effect. For example, the engaging wall 100b may be provided with anti-slip silicone, anti-slip rubber, or be provided with rib, grid pattern, and the like.

In some embodiments, the two engaging walls 100b extend from the engaging bottom surface 100a in a direction away from the engaging bottom surface 100a, and one end away from the engaging bottom surface 100a of each of the two engaging walls 100b is curved towards the other of the two engaging walls 100b. Specifically, the two engaging walls 100b form a “C” shape. The opening size of the “C” shape may be the same as or slightly smaller than the size of the temple of the smart glasses body. That is, the two engaging walls 100b are configured to hold the temple by interference fit. The size of the “C” shape formed by two engaging walls 100b may be adjusted according to the size of the temple. For example, when the size of the temple is large, the size of the “C” shape may be large. On the other hand, the size of the “C” shape may be small in order to improve the fixing effect. It should be noted that the shape mentioned above (i.e., “C” shape) is only an example, and the present disclosure is not limited thereto. In some embodiments, the shape of the temple may be a rectangle. In this case, the two engaging walls 100b may be adjusted their bending angles according to the rectangle. For example, the bending angle of one end of the two engaging walls 100b away from the engaging bottom surface 100a may be 90 degrees to better fit the temple.

In some embodiments, the circuit board component 11 may include a printed circuit board. For example, the printed circuit board may be composed of a substrate and circuits integrated on the substrate, but the present disclosure is not limited thereto. For example, the substrate may be a ceramic substrate composed of ceramic powder and glass fiber. Alternatively, the substrate may also be a plastic substrate, such as polyethylene terephthalate (PET), polycarbonate (PC), polymethyl methacrylate (PMMA), or polycycloolefin polymer (COP). However, the present disclosure is not limited thereto. In other embodiments, any substrate well known by a person having ordinary skill in the art may be used in the present disclosure. On the other hand, the circuit may include pure metals, metal alloys, metal nitrides, metal oxides, metal oxynitrides, and/or combinations thereof, but the present disclosure is not limited thereto.

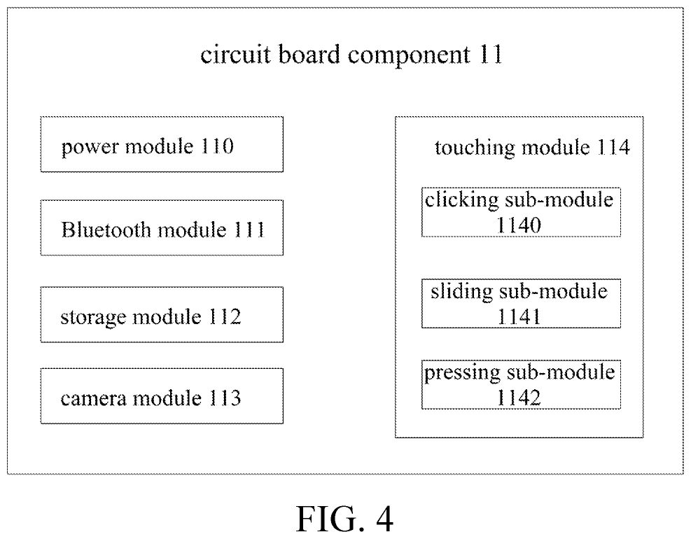

FIG. 4 is a block diagram of the circuit board component according to an embodiment of the present disclosure. As shown in the figure, in some embodiments, the circuit board component 11 may be divided into various modules according to functions. For example, the circuit board component 11 may include a power module 110, a Bluetooth module 111, a storage module 112, a camera module 113, etc., but the present disclosure is not limited thereto. Specifically, the power module 110 is used to monitor and/or manage the power of the camera component 12. For example, when the power of the camera component 12 is insufficient, the power module 110 may control the camera component 12 to enter a power-saving mode. The Bluetooth module 111 is used for wireless signal transmission. For example, the user may transmit an image photographed by the camera component 12 to a mobile terminal through the Bluetooth module 111 to view or edit the photographed image. Alternatively, the smart glasses body and the camera device 1 may be also connected to each other through the Bluetooth module 111 to achieve the effect of transmitting signals. The storage module 112 is used for storing the photographed images or videos. For example, the user may play the image in the storage module 112 through a display of the smart glasses body at any time. The camera module 113 is used to adjust the focus, photographing mode, etc. of the camera component 12. For example, the user may use the camera module 113 to control the camera component 12 for photography, video recording, recording, and the like. It should be noted that the circuit board component 11 of the present disclosure may also include other modules.

As shown in FIG. 3, in some embodiments, the camera device 1 further includes a touching component 14. The touching component 14 is disposed between the circuit board component 11 and the case 13, and the touching component 14 is electrically connected to the circuit board component 11. Specifically, the touching component 14 is used to sense the user's gesture, and send a signal to the circuit board component 11 according to the user's gesture. For example, the user's gesture may be a click, a swipe, a press, or a gesture recognized by a person having ordinary skill in the art. With different gestures, the user may operate the camera device 1 intuitively and simply.

In some embodiments, the touching component 14 includes a touching circuit board 140 and a touching sensor 141 electrically connected to each other, and the touching sensor 141 is between the touching circuit board 140 and the case. For example, the touching circuit board 140 may be a printed circuit board. For example, the touching circuit board 140 may be composed of a substrate and circuits integrated on the substrate, but the present disclosure is not limited thereto. Wherein, the substrate may be a ceramic substrate, a plastic substrate, or a Teflon substrate, but the present disclosure is not limited thereto. Any substrate well known by a person having ordinary skill in the art may be applied to the present disclosure. On the other hand, the circuit may include pure metals, metal alloys, metal nitrides, metal oxides, metal oxynitrides, and/or combinations thereof, but the present disclosure is not limited thereto.

In some embodiments, one side of the touching circuit board 140 has a connecting part 1400. The connecting part 1400 extends outward from the side of the touching circuit board 140 and is bent toward the circuit board component 11, and the connecting part 1400 is electrically connected to the circuit board component 11. However, the present disclosure is not limited thereto. In other embodiments, the connecting part 1400 may also be a connecting terminal, a spring, a connecting wire, or a suitable connecting element.

In some embodiments, the touching sensor 141 may be a flexible circuit board disposed in the accommodating groove 131 of the case 13. When the user's hand approaches or touches the case 13, the touching circuit board 140 sends a measurement signal to the circuit board component 11 according to the change in capacitance, resistance, or pressure measured by the touching sensor 141. It should be noted that the capacitance, resistance, or pressure mentioned above are only examples, and a person having ordinary skill in the art may also measure changes in other physical properties by disposing different types of touching sensors 141.

As shown in FIG. 4, in the case where the touching component 14 is provided, the circuit board component 11 may further include a touching module 114. The touching module 114 includes a clicking sub-module 1140, a sliding sub-module 1141, and a pressing sub-module 1142 and the like. Wherein, the clicking sub-module 1140 may control the camera component 12 according to the user's click. For example, when the user clicks once, the touching component 14 sends a first measurement signal. The circuit board component 11 controls the camera component 12 to photograph according to the first measurement signal. When the user clicks twice, the touching component 14 sends a second measurement signal. The circuit board component 11 controls the camera component 12 to start video recording according to the second measurement signal. When the user clicks three times, the touching component 14 sends a third measurement signal. The circuit board component 11 controls the camera component 12 to stop running according to the third measurement signal. Similarly, the sliding sub-module 1141 and the pressing sub-module 1142 may also store various preset situations in advance, and control the camera component 12 according to the preset situations corresponding to the user's operation. It should be noted that the description mentioned above is only an example, and the present disclosure may adjust the preset situations according to actual requirements or dispose different sub-modules.

In some embodiments, the camera device 1 further includes a recording component (not shown), the recording component is disposed between the circuit board component 11 and the case 13. The recording component is electrically connected to the circuit board component 11. In the case where the recording component is provided, the circuit board component 11 may further include a recording module. The recording module may control the operation of the recording component according to the measurement signal sent by the touching component 14.

As shown in FIG. 3, in some embodiments, the camera device 1 further includes a first electrical connecting component 15 passing through the base 10. One end of the first electrical connecting component 15 is electrically connected to the circuit board component 11, and the other end of the first electrical connecting component 15 is electrically connected to the smart glasses body. More specifically, the first electrical connecting component 15 passes through the engaging bottom surface 100a and the bottom plate 10a, and the first electrical connecting component 15 abuts against the smart glasses body and the circuit board component 11.

In some embodiments, the first electrical connecting component 15 may be a Pogo Pin composed of a plunger, a tube, and a spring. The elasticity of the spring of the Pogo Pin may be adjusted according to the application requirements to achieve a more stable contact effect. Alternatively, Pogo Pin may also be electroplated with gold, nickel, or their alloys on the surface according to the application requirements to increase conductivity and avoid oxidation. In this embodiment, the number of Pogo Pins is three, but the present disclosure is not limited thereto. In other embodiments, the number of Pogo Pin may be one, two, four, or more than four, which may be adjusted according to actual requirements.

In the case where the first electrical connecting component 15 is provided, a positioning part (not shown) may be disposed on the engaging bottom surface 100a or the bottom plate 10a. Therefore, the user may position the first electrical connecting component 15 more accurately and easier. For example, the engaging bottom surface 100a may be disposed with a positioning protrusion, and the temple of the smart glasses body may be disposed with a positioning groove. The positioning protrusion and the positioning groove correspond to each other. Alternatively, the temple of the smart glasses body may be disposed with a positioning recess corresponding to the first electrical connecting component 15. When the camera device 1 and the smart glasses are connected to each other, a part of the first electrical connecting component 15 is engaged with the positioning recess on the temple. It should be noted that the positioning methods mentioned above are only examples, and the positioning elements mentioned above or other types of positioning elements may also be disposed at the same time by a person having ordinary skill in the art according to actual requirements.

In some embodiments, the case 13 includes a bottom plate 13a and a side plate 13b connected to each other. In some embodiments, the side plate 13b of the case 13 is bent and extended from one end of the bottom plate 13a, and the side plate 13b and the bottom plate 13a of the case 13 form a preset angle. More specifically, the side plate 13b extends in a direction away from the bottom plate 13a from one end of the bottom plate 13a, and the angle between the side plate 13b and the bottom plate 13a is about 90 degrees. The relationship between the side plate 13b and the bottom plate 13a is similar to the relationship between the side plate 10b and the bottom plate 10a, so the description in detailed thereof is omitted. It should be noted that the camera opening 130 is on the side plate 13b. In some embodiments, the bottom plate 13a includes an outer surface and an inner surface opposite to each other, and the touching sensor 141 may be disposed on the inner surface of the bottom plate 13a. More specifically, the outer surface is a flat surface, and the inner surface is recessed to form an accommodating groove 131. The touching sensor is disposed in the accommodating groove 131.

In some embodiments, the camera opening 130 of the case 13 may include a step part 1300. Wherein, adhesives 17 and a lens 18 are disposed on the step part 1300 in sequence. The lens 18 is fixed on the casel3 by the adhesives 17. For example, the lens 18 may be a wide-angle lens, a fisheye lens, a protective lens, or a functional lens 18 well known by a person having ordinary skill in the art. It should be noted that the present disclosure is not limited to one step part. For example, the number of the lens 18 may be a plurality. The plurality of lenses 18 may be used to filter light in different wavelength bands to improve image quality. Therefore, in the case where the plurality of lenses 18 is provided, the number of the step parts may also be adjusted according to the number of the lenses 18.

In some embodiments, the lens 18 mentioned above is at one side of the camera opening 130, and the camera component 12 is at the other side of the camera opening 130. Wherein, the camera component 12 includes a lens and a photosensitive element, but the present disclosure is not limited thereto. In some embodiments, the camera component 12 may further include an anti-shake mechanism, a focus adjustment mechanism, and the like. In practical applications, after light from the outside passes through the lens 18 and the lens in sequence, the light is imaged on the photosensitive element and converted into electronic signals. Furthermore, the electronic signal after signal conversion (for example, Fourier transform) is an image or a video that may be viewed by the user.

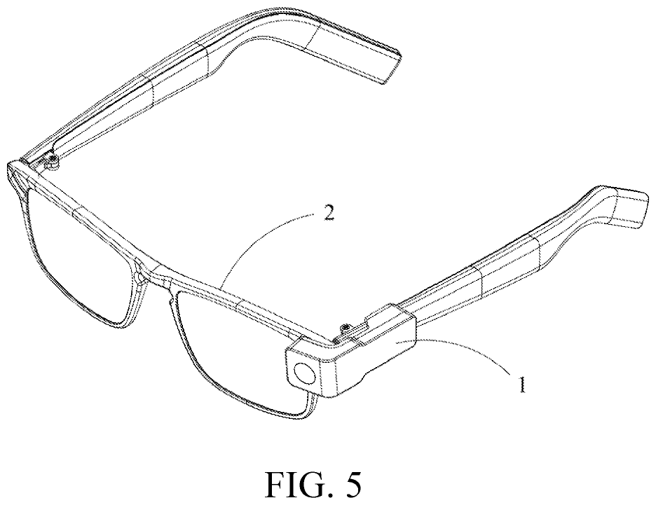

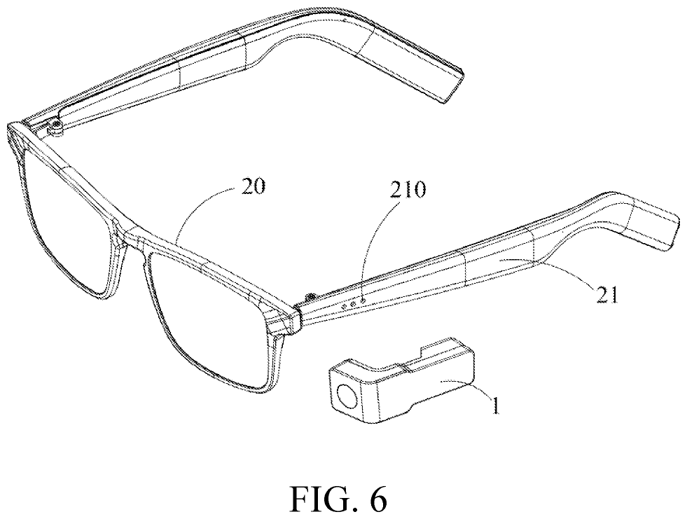

FIG. 5 to FIG. 6 are a schematic diagram and an exploded view of the smart glasses according to an embodiment of the present disclosure. As shown in the figures, the smart glasses include a smart glasses body 2 and the camera device 1 as described above. The smart glasses body 2 includes a frame 20, two temples 21, a controlling component, and a battery component. The two temples 21 are respectively disposed on two sides of the frame 20, and at least one of the two temples 21 has a second electrical connecting component 210. The controlling component is disposed in the temple 21 and electrically connected to the second electrical connecting component 210. The battery component is disposed in temple 21 and electrically connected to the controlling component. The camera device 1 is detachably disposed on one of the two temples 21 and electrically connected to the second electrical connecting component 210. In some embodiments, both of the two temples 21 have a second electrical connecting component 210, and the camera device 1 is detachably disposed on either of the two temples 21.

In some embodiments, the second electrical connecting component 210 may be a Pogo Pin, but the present disclosure is not limited thereto. In other embodiments, the second electrical connecting component 210 may also be a connecting element such as a connecting terminal well known by a person having ordinary skill in the art. More specifically, the second electrical connecting component 210 and the first electrical connecting component 15 mentioned above correspond to each other. Therefore, various details and changes of the second electrical connecting component 210 may be referred to hereinbefore, and the description in detailed thereof is omitted.

In some embodiments, the second electrical connecting component 210 may be a metal contact. In some embodiments, the second electrical connecting component 210 may be a metal contact with a flat surface. In some embodiments, the second electrical connecting component 210 is aligned with the outer surface of the temple 21. In some embodiments, the second electrical connecting component 210 is recessed on the outer surface of the temple 21. For example, the second electrical connecting component 210 and the outer surface of the temple 21 have a step difference. Alternatively, the surface of the electrical connecting component 210 is disposed with a recessing part recessed inward, and the first electrical connecting component 15 is a Pogo Pin. In the case mentioned above, the first electrical connecting component 15 falls into the second electrical connecting component 210 due to the elasticity thereof and the step difference or the recessing part when the first electrical connecting component 15 is aligned with the second electrical connecting component 210. Therefore, a positioning effect and positioning feel are achieved.

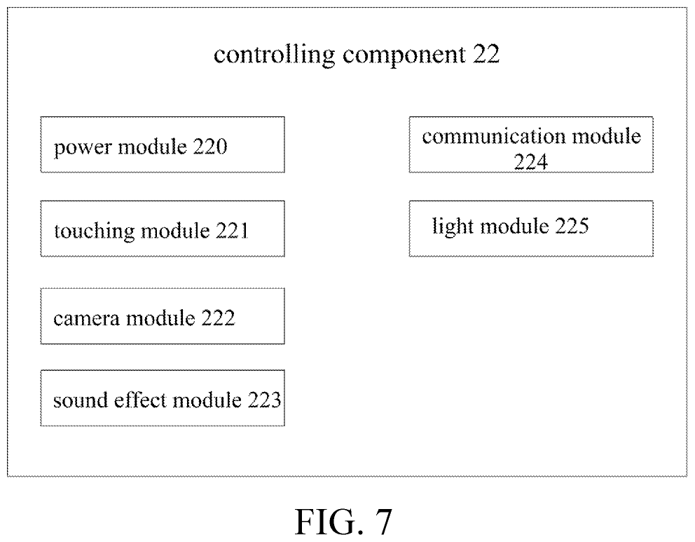

FIG. 7 is a block diagram of the controlling component according to an embodiment of the present disclosure. As shown in the figure, in some embodiments, the controlling component 22 is used to control the operation of the smart glasses body 2, and the controlling component 22 may be divided into various modules according to functions. For example, the controlling component 22 may include a power module 220, a touching module 221, a camera module 222, etc., but the present disclosure is not limited thereto. Wherein, the power module 220 is used to manage the power of the smart glasses body 2 and may also be used to manage the power of the camera device 1. That is, when the camera device 1 is electrically connected to the smart glasses, the user may view or manage the power of the camera device 1 through the smart glasses body 2. Similarly, the camera module 222 is used to manage the operation of the camera component 12 in the camera device 1. That is, when the camera device 1 is electrically connected to the smart glasses body 2, the user may use the smart glasses body 2 to control the camera component 12 to photograph or record video. On the other hand, the touching module 221 may send control signals according to the user's touch on the lens 18, the temple 21, or the frame 20, so as to control the operation of components such as a display of the smart glasses body 2 or the camera of the camera device 1.

In some embodiments, the smart glasses body 2 may further include a speaker and/or a microphone, and the speaker and/or the microphone may be disposed in the smart glasses body 2. In the case where the speaker and/or the microphone are provided, the controlling component 22 may further include a sound effect module 223 used to manage the functions of broadcasting or recording. It should be noted that when the camera device 1 is electrically connected to the smart glasses body 2, the user may also use the controlling component 22 in the smart glasses body 2 to control the recording component in the camera device 1 to record.

In some embodiments, the smart glasses body 2 further includes a communication component disposed in at least one of the two temples 21, and the communication component is electrically connected to the controlling component 22. The communication component may perform signal transmission based on one of the wireless communication technologies. For example, the communication component may use Bluetooth transmission technology, wireless network technology (e.g., Wi-Fi), or one of the other wireless transmission technologies. The user may connect the smart glasses with electronic equipment such as a mobile terminal through the communication component. In some embodiments, the signal transmission between the smart glasses body 2 and the camera device 1 may also be performed through Bluetooth. In the case where a communication component is provided, the controlling component 22 may also include a communication module 224 to manage the operation of the communication component.

In some embodiments, the smart glasses body 2 further includes a light component, and a part of the light component is exposed from the frame 20, the temple 21, and/or the lens 18. Furthermore, the light component is electrically connected to the controlling component 22 and changes the light according to the signal sent by the controlling component 22, so that the user may determine the status of the smart glasses by the flickering and color changing of the light. In the case where the light signal component is provided, the controlling component 22 may further include a light module 225 to manage the operation of the light component.

In summary, the camera device of the present disclosure includes a base and a circuit board component, a camera component, and a case located thereon. Furthermore, the camera device may be detachably connected to the smart glasses through the engaging part on the base, so that the user may quickly replace different camera devices according to their requirements. Therefore, a camera device of smart glasses with a stable connection and quick disassembly may be achieved by the present disclosure.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A camera device of smart glasses, comprising:
a base having an engaging part, wherein the engaging part is for being detachably connected to a temple of a smart glasses body;
a circuit board component disposed on the base;
a camera component disposed on the base, wherein the camera component is electrically connected to the circuit board component; and
a case disposed on the base, wherein the case covers the circuit board component and the camera component, the case has a camera opening, and a part of the camera component is exposed from the camera opening.

2. The camera device of smart glasses of claim 1, wherein the engaging part has an engaging bottom surface and two engaging walls on two sides of the engaging bottom surface, the engaging bottom surface cooperates with the two engaging walls to form an engaging groove, and the engaging groove is configured to correspond to the temple of the smart glasses body.

3. The camera device of smart glasses of claim 2, wherein the two engaging walls extend from the engaging bottom surface in a direction away from the engaging bottom surface, and one end away from the engaging bottom surface of each of the two engaging walls is curved towards another of the two engaging walls.

4. The camera device of smart glasses of claim 3, wherein the two engaging walls are configured to hold the temple by interference fit.

5. The camera device of smart glasses of claim 1, further comprising a touching component, wherein the touching component is disposed between the circuit board component and the case, and the touching component is electrically connected to the circuit board component.

6. The camera device of smart glasses of claim 5, wherein the touching component comprises a touching circuit board and a touching sensor electrically connected to each other, and the touching sensor is between the touching circuit board and the case.

7. The camera device of smart glasses of claim 6, wherein the case comprises a bottom plate and a side plate connected to each other, the side plate of the case is bent and extended from one end of the bottom plate, the side plate and the bottom plate of the case form a preset angle, the camera opening is at the side plate, the bottom plate comprises an outer surface and an inner surface opposite to each other, and the touching sensor is disposed on the inner surface of the bottom plate.

8. The camera device of smart glasses of claim 7, wherein the outer surface is a flat surface, an accommodating groove is recessed on the inner surface, and the touching sensor is disposed in the accommodating groove.

9. The camera device of smart glasses of claim 1, further comprising a first electrical connecting component passing through the base, wherein one end of the first electrical connecting component is electrically connected to the circuit board component, and another end of the first electrical connecting component is for being electrically connected to the smart glasses body.

10. The camera device of smart glasses of claim 9, wherein the first electrical connecting component is a Pogo Pin.

11. The camera device of smart glasses of claim 10, wherein the engaging part has an engaging bottom surface and two engaging walls on two sides of the engaging bottom surface, the engaging bottom surface cooperates with the two engaging walls to form an engaging groove, and the first electrical connecting component passes through the engaging bottom surface.

12. The camera device of smart glasses of claim 11, wherein the base comprises a bottom plate and a side plate connected to each other, the side plate of the base is bent and extended from one end of the bottom plate, the side plate and the bottom plate of the base form a preset angle, the camera component is at the side plate of the base, and the engaging part is at the bottom plate of the base.

13. Smart glasses, comprising:
a smart glasses body, comprising:
a frame;
two temples respectively disposed on two sides of the frame, wherein at least one of the two temples has a second electrical connecting component;
a controlling component disposed in at least one of the two temples, wherein the controlling component is electrically connected to the second electrical connecting component; and
a battery component disposed in at least one of the two temples, wherein the battery component is electrically connected to the controlling component; and
the camera device of smart glasses of claim 1 detachably disposed on one of the two temples, wherein the camera device is electrically connected to the second electrical connecting component.

14. The smart glasses of claim 13, wherein the smart glasses body further comprises a communication component disposed in at least one of the two temples, and the communication component is electrically connected to the controlling component.

15. The smart glasses of claim 13, wherein the engaging part has an engaging bottom surface and two engaging walls on two sides of the engaging bottom surface, the engaging bottom surface cooperates with the two engaging walls to form an engaging groove, and the engaging groove is configured to correspond to the temple of the smart glasses body.

16. The smart glasses of claim 13, wherein the camera device further comprises a touching component, wherein the touching component is disposed between the circuit board component and the case, and the touching component is electrically connected to the circuit board component.

17. The smart glasses of claim 13, wherein the camera device further comprises a first electrical connecting component passing through the base, wherein one end of the first electrical connecting component is electrically connected to the circuit board component, and another end of the first electrical connecting component is for being electrically connected to the smart glasses body.
